(19) United States
(12) Patent Application Publication
(10) Pub. No.: US 2002/0141635 A1
(43) Pub. Date: Oct. 3, 2002

(54) Method and system for adjusting stereoscopic image to optimize viewing for image zooming

(76) Inventors: David C. Swift, Cortlandt Manor, NY (US); Joshua Ong, Pomona, NY (US)

Correspondence Address: VRex, Inc., 85 Executive Blvd., Elmsford, NY, 10523, US

(21) Appl. No.: 10/057,682

(22) Filed: Jan. 24, 2002

Related U.S. Application Data
(60) Provisional application No. 60/263,736, filed on Jan. 24, 2001.

(51) Int. Cl. G06K 9/00

(52) U.S. Cl. 382/154

(57) ABSTRACT

Methods and systems are described for zooming a stereoscopic image. The image is typically divided into a plurality of regions. A value is defined for each region, such as a minimum parallax value or a function of the minimum parallax value. A zoom area is selected having a boundary intersecting at least one of the regions. The values within the intersected regions are compared to determine a preferred value based on predetermined criteria. The zoom area is shifted by the preferred value or a function of the preferred value.

### CROSS REFERENCE TO A RELATED APPLICATION

This application is related to a U.S. Provisional Application Serial No. 60/263,736 ('736) filed on Jan. 24, 2001 by David C. Swift, one of the inventors of this application. The '736 application is hereby incorporated by reference.

### BACKGROUND OF THE INVENTION

1. Field of the Invention

This invention relates to methods for zooming a stereoscopic image, particularly for controlling parallax and image shift adjustments to facilitate arbitrary image zooming of a three-dimensional stereoscopic image.

2. Description of the Prior Art

Zooming into a two-dimensional (2D) image is a common operation for viewing enhancement. Specific multi-resolution image file formats and web based server systems are used to provided image zooming capabilities. Once such system is called FlashPix. Several companies including MGI Software market FlashPix compatible web servers. FlashPix offers various features, including: the ability to store various resolutions of an image in a single file; use of object linking and embedding (OLE) structured storage format, enabling developers to extend the format; built-in linking support, allowing different applications to link to the same image in different ways; and built-in support for digital watermarks.

When dealing with three-dimensional (3D) stereoscopic image content, a standard 2D zooming system will not produce optimum results when zooming into a 3D stereoscopic image. To illustrate, consider the 3D stereoscopic image illustrated in FIG. 1. The two triangle-like objects represent the right and left views of a 3D object. For illustrative purposes, we will represent the left and right images as layered composites. A 3D stereoscopic image would normally be displayed in a time sequential, spatial, or other format that is well known to someone skilled in the art. In this example, the triangle object will appear to come out of the viewing display, generally due to the crossed disparity relationship of the objects. The dashed rectangle in FIG. 1 illustrates the desired zoom region to be magnified. FIG. 2 illustrates the results of zooming into this 3D stereoscopic image. As illustrated in FIG. 2, there is a stereoscopic window violation on the top border making the image very hard to fuse by a viewer. A stereoscopic window violation is well known to someone skilled in the art of stereoscopic imaging.

The stereoscopic window is the reference plane of zero parallax. Generally it is considered to be at the surface of the display device, such as a CRT monitor, or a projection screen but can be defined on many different types of viewing systems. Its boundaries are the edges of the displayable or projection area on the types of devices just mentioned. Objects that have negative parallax appear to project between the window and the viewer, whereas objects with positive parallax appear to be behind the window in three-dimensional space. When an object has negative parallax, but is positioned such that a portion of one or both of the two views is cropped by the edge of the window resulting in a difficult to view image.

Another condition that can arise from normal 2D zooming techniques when they are used on stereoscopic images is an undesirably large increase in the magnitude of the image's parallax. Objects with abnormally large amounts of parallax can be very difficult to fuse. When an image is zoomed using 2D techniques, the magnitude parallax relative to the size of the image can increase such that it is more than would be desired. Problems due to excessive parallax are well known to someone skilled in the art of stereoscopic imaging.

This example illustrates that conventional 2D systems designed for zooming into a 2D image do not work well with 3D stereoscopic images. Therefore, it is desirable to provide a system that allows a conventional 2D zooming system to be used for 3D stereoscopic image content.

### SUMMARY OF THE INVENTION

The above discussed and other problems and deficiencies of the prior art are overcome or alleviated by the several methods and apparatus of the present invention for zooming a stereoscopic image. One method includes determining a parallax value for a region of the image, selecting a zoom area having a boundary intersecting the region, and shifting the zoom area by the parallax value or a function of the parallax value.

In another embodiment, the method for zooming a stereoscopic image includes determining a plurality of parallax values for corresponding regions of the image, selecting a zoom area having a boundary intersecting at least a portion of the regions, comparing the parallax values for the intersected regions to determine a shift parallax value, and shifting the zoom area by the shift parallax value or a function of the shift parallax value. In preferred embodiments, the shift parallax value is the minimum parallax value of the intersected regions.

In a further embodiment of the instant method, the image is divided into a plurality of regions, a value is defined for each region, a zoom area is selected having a boundary intersecting at least one of the regions, the values are compared for the intersected regions to determine a preferred value based on predetermined criteria, and the zoom area is shifted by the preferred value or a function of the preferred value. In preferred embodiments, the predetermined criteria include the minimum value of the intersected values. Where the shifting of the zoom area is a function of the value, the function includes division of the value divided by two plus an offset, wherein the offset is selected from the group consisting of zero to place the stereoscopic window right at the closest object when zoomed, a negative value to push the closest object slightly behind the stereo window when zoomed, and a positive value to pull the closest object slightly out of the window when zoomed. In another preferred embodiment, at least one of the values includes the minimum parallax value for the corresponding region.

A further method for zooming a stereoscopic image includes using an array of regions that divide the stereoscopic image into sections and defining a value for each region. The values associated with each region indicate a shift value that is used to adjust the relationship of the right and left image during a zooming operation. The sections and values may be automatically determined from a 3D object model. The sections and values can also be determined from a user input of depth values in the regions and interpolating values in between the regions. The sections and values can also be determined using parallax adjustments for successive zooming operations dependent on a current zoom level. The sections and values can be used with multiple levels of granularity for higher definition of sections and values in select areas of the image.

The features discussed above and other features and advantages of the present invention will be appreciated and understood by those skilled in the art from the following detailed description and drawings thereof.

### BRIEF DESCRIPTION OF THE DRAWINGS

FIG. 1 illustrates a representation of a 3D image having a rectangular zoom region;

FIG. 2 represents a zooming problem associated with 3D stereoscopic images known as stereo window violations;

FIG. 3 represents a 3D stereoscopic image and a coordinate frame therefore;

FIG. 4 illustrates a definition of a point parallax;

FIG. 5 illustrates the relationships of parallax values;

FIG. 6 illustrates a step of selecting the zoom area;

FIG. 7 illustrates an image shift modifier matrix superimposed over in image;

FIG. 8 illustrates the projection of a merged point;

FIG. 9 depicts sample entries in an image shift modifier matrix;

FIG. 10 illustrates of multiple image shift modifier matrixes;

FIG. 11 illustrates a modifier matrix having the zoom area superimposed thereon;

FIG. 12 identifies of the matrix values to scan;

FIG. 13 illustrates selection of shift values;

FIG. 14 demonstrates application of the shift value;

FIG. 15 is a representation of a zoomed image fixed with image shift operation; and

FIG. 16 illustrates shift value selection for subsequent zooming operations.

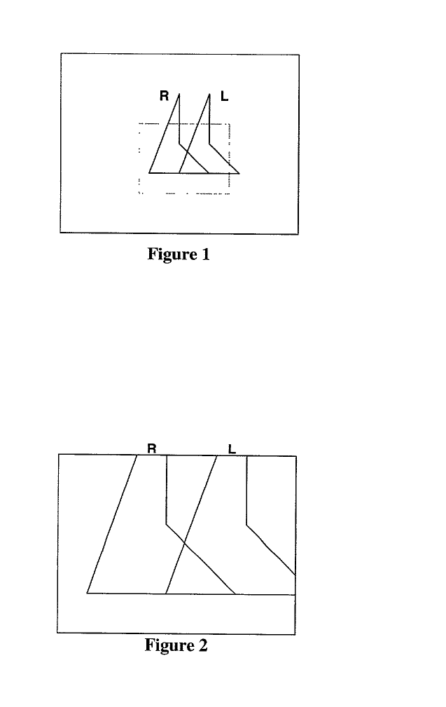

### DETAILED DESCRIPTION OF THE ILLUSTRATIVE EMBODIMENTS

Herein disclosed is a system for zooming a stereoscopic image utilizing a determined array of values. These values may correspond to the minimum parallax value of various areas of a stereoscopic image. When a desired zooming region is selected, the borders of this region will intersect areas in the pre-calculated array. All of the values in these intersected areas are compared and a shift parallax value is determined. The shift parallax value may be the minimum parallax value of the intersected areas. This value is used as a shift modifier and is applied to the right and left images to generate a suitable zoomed image.

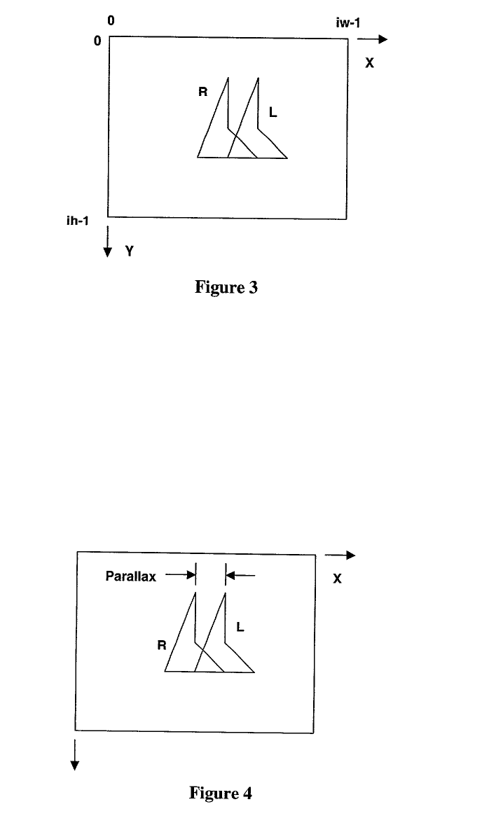

An exemplary 3D stereoscopic image is illustrated in FIG. 3. To simplify the figures, the left and right images are illustrated superimposed. In a typical 3D stereoscopic image, the left and right images are stored separately. A process known as multiplexing is used to display them on a 3D stereoscopic display system. Typical storage and display systems for 3D stereoscopic images are known to those skilled in the art. FIG. 3 also illustrates a coordinate system for the image. It is assumed for this example that the right and left images are the same size. However, it is understood that the images may be different sizes; wherein the method and system disclosed herein is equally applicable. The image width, typically measured in pixels, is indicated by the value “iw”. The image height, also typically measured in pixels, is indicated by the value “ih”. The individual pixels are numbered starting from zero in the upper left hand corner. As viewed in FIG. 3, the pixel coordinate values increase to the right and down. The 3D stereoscopic image in this example includes a triangle like object that appears to project from of the display surface towards the viewer due to the crossed disparity of the image. The “L” and “R” labels in FIG. 3 indicate which object is for the left eye and which is for the right eye.

A corresponding point is a point on an object that is seen by both eyes. When a stereoscopic image is displayed on a 3D stereoscopic display system, a corresponding point will appear in the left image and the right image. The horizontal distance between a corresponding point in the right and left images is called the parallax. FIG. 4 illustrates the parallax of the corresponding point at the tip of the triangle like object.

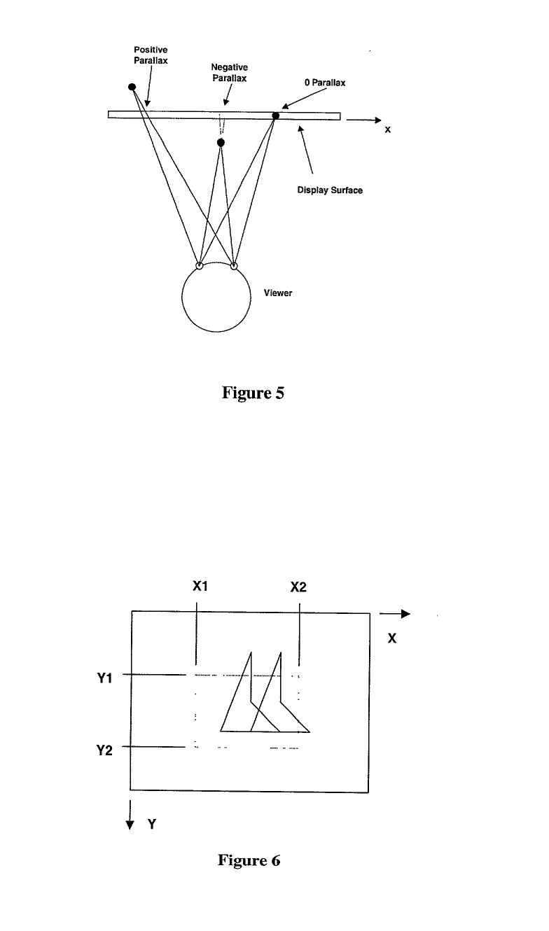

For a 3D stereoscopic image, the parallax is typically measured in pixels. FIG. 5 illustrates how the sign of the parallax value is determined. When a corresponding point appears behind the image display surface, its parallax value is positive. When a corresponding point appears in front of the image display surface, its parallax value is negative. When a corresponding point appears exactly at the surface of the display, its parallax value is zero.

A zoom region is used to indicate the desired region of an image to zoom into. The zoom region is specified as a rectangular region with left X coordinate X1, right X coordinate X2 top Y coordinate Y1 and bottom Y coordinate Y2 as illustrated in FIG. 6. It is best if the zoom region has the same aspect ratio as the original image or as the display system. If the zoom region is not the same aspect ratio as the display surface, then the image will need to fit within the display surface or expanded to cover all pixels of the display surface. Techniques for dealing with varying aspect ratio zooming regions are well known to someone skilled in the art. All of these methods can be applied to the invention described in this document and are considered to be simple expansions of this invention.

This zoom region is typically selected by a user by dragging a rectangle on the display surface with a mouse or by clicking in the center of the desired zooming region and selecting a zoom factor. The end result of any zooming user interface is a zooming rectangle. The various methods of creating a graphical users interface to specify a zooming regions is not part of the scope of this invention.

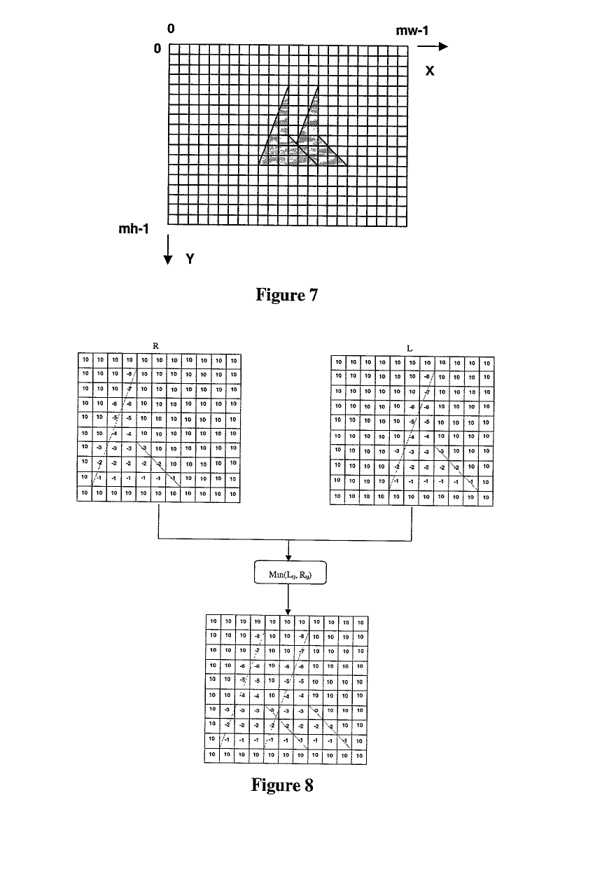

In order to correctly zoom into a 3D stereoscopic image, information about the image is required. Specifically, to correct for stereoscopic window violations (well known in the art) it is important to determine the extreme parallax values for specific regions of the image. To accomplish this, we use an Image Shift Modifier Matrix (ISMM), which is an array of regions that divide the stereoscopic image into sections and define a value for each region. The regions can be of any shape but rectangular regions are most useful as illustrated in FIG. 7. The values associated with each region indicate a shift value that is used to adjust the relationship of the right and left image during a zooming operation.

One can calculate an ISMM for one of the two views that make up a stereoscopic image by calculating the parallax between each pixel of an ISMM region and the pixel with which it is merged in the corresponding view. The value of the region is the minimum value of all such parallax values divided by two plus a small offset, as illustrated below:

$$Value = \frac{Min ( all parallax values in region )}{2} + offset \qquad ( 1 )$$

Once an ISMM is calculated for each view of the stereoscopic image, the two ISMMs can be combined such that the value of each region in the final ISMM is the minimum of the corresponding regions in each of the two source ISMMs as illustrated in FIG. 8.

The offset used in equation (1) is zero to place the stereoscopic window right at the closest object when zoomed, a negative value to push the closest object slightly behind the stereo window when zoomed, and a positive value to pull the closest object slightly out of the window when zoomed. The larger the magnitude of offset, the greater the desired effect on the final zoomed image. This value is selected to suit the designer's tastes.

When dealing with computer generated 3D stereoscopic images, it may be possible to easily generate an ISMM using an image depth map. When generating an ISMM for a live photograph, it is best to use an interactive stereoscopic point selector to build up a grid of depth values. For example, an ideal method would be to provide a mouse driven system that allowed an author to move a cursor around in 3D space with the desired stereoscopic image being displayed as an overlay. The author could use this tool to build a depth map grid just in front of the various image object details. This depth map grid could then be quantized into an ISMM by sampling points on the depth map grid and determining the minimum parallax value for each ISMM region. Furthermore, an algorithm could be developed that used current technologies of pattern matching to automatically calculate minimum parallax values for each region of the stereo image. Methods for generating ISMMs need not be limited to these techniques, however.

It is also possible to store other values in regions of an ISMM to achieve other results or to exaggerate the 3D stereoscopic effect for various parts of the image. One skilled in the art of multiplexing and aligning stereoscopic images would be able to select customized ISMM values to achieve specific 3D stereoscopic effects.

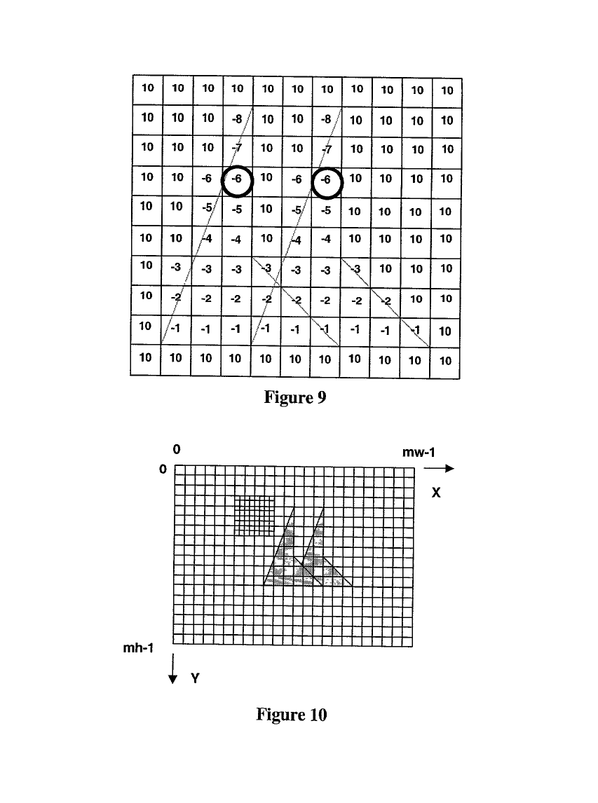

An example ISMM is illustrated in FIG. 9 for the triangle shaped objects used in the examples above. As the entries show, the triangle object is coming out of the screen since the entries in the ISMM are negatives where the objects intersect the ISMM regions. It is also apparent that the top of the object is leaning out of the screen in 3D since the ISMM values are more negative at the top of the objects.

It is also possible to have multiple ISMM's defined for a single or multiple images as illustrated in FIG. 10. This would allow greater depth accuracy to be represented for specific areas of an image that have lots of depth detail. These multiple ISMM's can be processed in a similar fashion as a single ISMM. While a single ISMM is described, one skilled in the art will appreciate that multiple ISMMs may be employed within the scope of the method and system described herein. With multiple ISMMs, the zooming region is preferably checked with all ISMMs used.

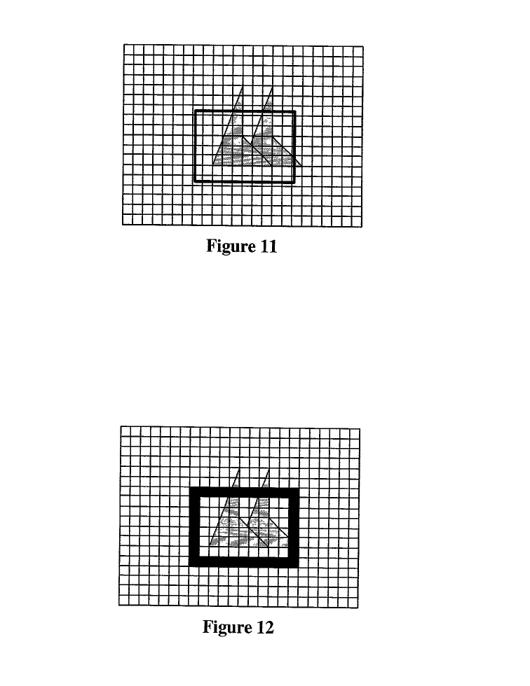

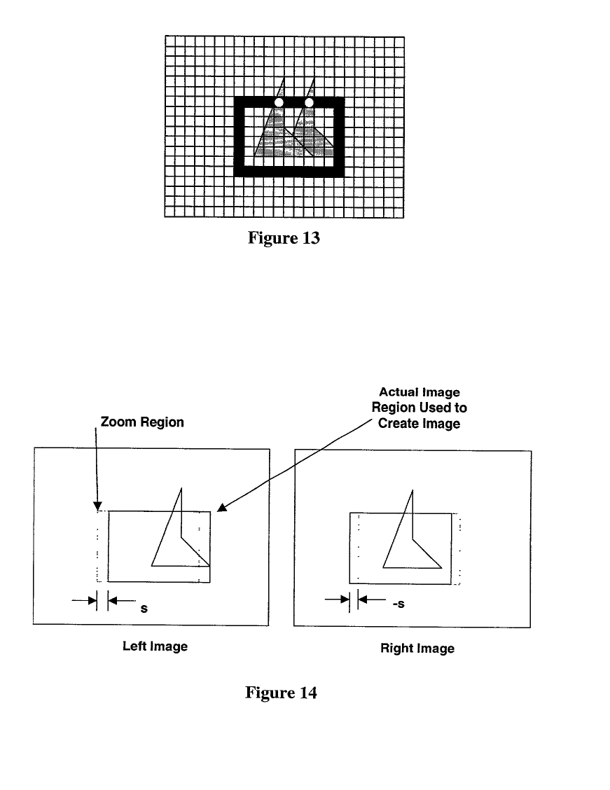

The zooming region is then superimposed over the ISMM as illustrated in FIG. 11. The boundary of the zoom region intersects certain ISMM blocks. When a zooming region falls on the border of an ISMM grid, select the grid entry inside the zooming region is preferably selected. Any regions of the ISMM that are intersected by the zoom region are marked as illustrated in FIG. 12 to be scanned for a shift value, which in certain embodiments is the minimum value. All of the intersected regions are compared to each other. A shift parallax value, “S”, which in certain embodiments is the minimum value, is determined from the compared values. In the example described herein, the minimum value occurs at the top of the triangle objects since they are leaning out of the screen as illustrated by the white circles in FIG. 13. Referring back to FIG. 9, a value of S=−6 is the minimum value of the marked regions.

This minimum value is then used as a shifting modifier for the zoom region. For the left image, the zooming region is shifted to the left by an amount of S pixels to form the left zooming region. For the right image, the zooming region is shifted to the right by an amount of S pixels to form the right zooming region. For this example, since S is negative, the shifting directions are opposite as illustrated in FIG. 14.

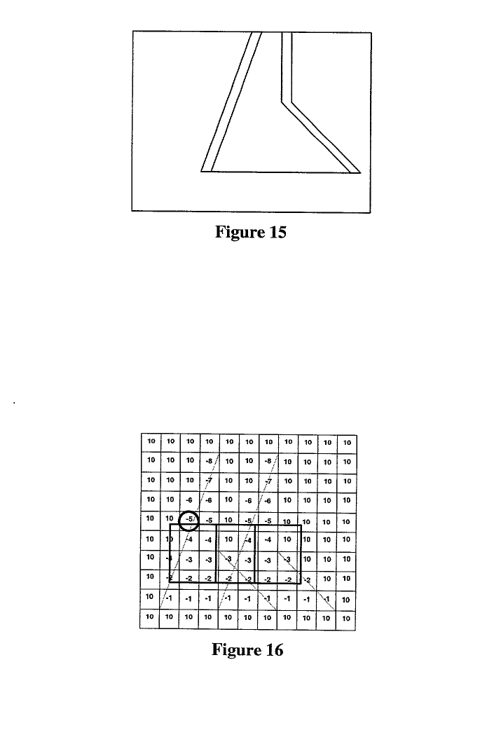

These modified shifting regions are then used to construct the new zoomed left and right image pair. The left sub image as specified by the left zooming region and the right sub image as specified by the right zooming region are then combined to form the resulting 3D stereoscopic image as illustrated in FIG. 15.

If further zooming is required, the current value of S must be considered when scanning the ISMM for a minimum value. For example, if a new zooming region around the center of the object in FIG. 15 was selected, then two zooming region boxes (offset from the original by +/−S) must be compared to the ISMM. The resulting minimum value from this comparison is the new value of S. It is important to translate the zooming region back into the original un-zoomed image coordinates since the ISMM was based on the original un-zoomed image as illustrated in FIG. 16.

In alternative embodiments, a left and right ISMM matrix can be created and stored with the respective image. The method and system described herein may be applied to facilitate zooming functions separately for each image and subsequently multiplexed.

In a further alternative embodiment, zoom functionality may be facilitated for a motion image. For example, a time varying ISMM may be generated that can be used to adjust the image shift in real-time.

Various benefits and advantages may be derived from the method and system described herein. For instance, it is not important to be perfectly accurate with an ISMM value, thus increasing efficiency. Minor issues with zoom scale (within the resolution of the ISMM) can be ignored in most cases, allowing use of an ISMM having a lower resolution than the actual pixel image.

Further, the method and system may readily be employed where left and right images are of identical or different sizes. Where the sizes are different, multiplexing parameters are preferably used that describe how the initial (unzoomed) stereoscopic image is formed from the left and right images. From these multiplexing parameters, an ISMM can be created for this unzoomed stereoscopic image. These multiplexing parameters can then be used to further modify the right and left zooming regions before applying the zoom function as described herein.

Other benefits and advantages also are derived from the zooming function herein. For multiple zooming applications, the same ISMM can be used; preferably, the system tracks of the current zooming region to scale the results. Also, it is possible to have multiple ISMM's for a single image. For example, a special area of the image may require a more detailed ISMM. When a new zooming region is selected, it can be compared to a list of all possible ISMM's stored within the image. Further, an ISMM is typically aligned with the stereoscopic image, therefore the aspect ratio of the ISMM grid does not need to match the aspect ratio of the stereoscopic image.

The method and system described herein can be embodied in the form of computer- implemented processes and apparatuses for practicing those processes. The present method and system can also be embodied in the form of computer program code containing instructions, embodied in tangible media, such as floppy diskettes, CD-ROMs, hard drives, or any other computer-readable storage medium, wherein, when the computer program code loaded into and executed by a computer, the computer becomes an apparatus for practicing the method and system. The present method and system can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the method and system. When the implementation is on a general-purpose microprocessor, the computer program code segments configure the microprocessor to create specific logic circuits.

While preferred embodiments have been illustrated and described, various modifications and substitutions may be made thereto without departing from the spirit and scope of the invention. Accordingly, it is to be understood that the present invention has been described by way of illustrations and not limitation.

What is claimed is:

1. A method for zooming a stereoscopic image comprising:
determining a parallax value for a region of the image;
selecting a zoom area having a boundary intersecting the region; and
shifting the zoom area by the parallax value or a function of the parallax value.

2. A method for zooming a stereoscopic image comprising:
determining a plurality of parallax values for corresponding regions of the image;
selecting a zoom area having a boundary intersecting at least a portion of the regions;
comparing the parallax values for the intersected regions to determine a shift parallax value; and
shifting the zoom area by the shift parallax value or a function of the shift parallax value.

3. The method as in claim 2, wherein the shift parallax value is the minimum parallax value of the intersected regions.

4. A method for zooming a stereoscopic image comprising:
dividing the image into a plurality of regions;
defining a value for each region;
selecting a zoom area having a boundary intersecting at least one of the regions;
comparing the values for the intersected regions to determine a preferred value based on predetermined criteria; and
shifting the zoom area by the preferred value or a function of the preferred value.

5. The method as in claim 4, wherein the predetermined criteria comprises the minimum value of the intersected values.

6. The method as in claim 4, wherein shifting of the zoom area is by a function of the value, the function comprising division of the value by two.

7. The method as in claim 6, wherein the function further comprises addition of an offset, the offset selected from the group consisting of zero to place the stereoscopic window right at the closest object when zoomed, a negative value to push the closest object slightly behind the stereo window when zoomed, and a positive value to pull the closest object slightly out of the window when zoomed.

8. The method as in claim 4, wherein the value comprises the minimum parallax value for the corresponding region divided by two.

9. The method as in claim 8, wherein the value further comprises an offset, the offset selected from the group consisting of zero to place the stereoscopic window right at the closest object when zoomed, a negative value to push the closest object slightly behind the stereo window when zoomed, and a positive value to pull the closest object slightly out of the window when zoomed.

10. The method as in claim 4, wherein at least one of the values comprises the minimum parallax value for the corresponding region.

11. An article of manufacture comprising:
a computer usable medium having computer readable program code means embodied therein for zooming a stereoscopic image, the computer readable program code means in the article of manufacture comprising:
computer readable program code means for dividing the image into a plurality of regions;
computer readable program code means for defining a value for each region;
computer readable program code means for selecting a zoom area having a boundary intersecting at least one of the regions;
computer readable program code means for comparing the values for the intersected regions to determine a preferred value based on predetermined criteria; and
computer readable program code means for shifting the zoom area by the preferred value or a function of the preferred value.

12. A computer program product for use with a graphics display device, the computer program product comprising:
a computer usable medium having computer readable program code means embodied therein for zooming a stereoscopic image, the computer readable program code means in the article of manufacture comprising:
computer readable program code means for dividing the image into a plurality of regions;
computer readable program code means for defining a value for each region;
computer readable program code means for selecting a zoom area having a boundary intersecting at least one of the regions;
computer readable program code means for comparing the values for the intersected regions to determine a preferred value based on predetermined criteria; and
computer readable program code means for shifting the zoom area by the preferred value or a function of the preferred value.

13. A program storage device readable by a machine, tangibly embodying a program of instructions executable by the machine to perform method steps for zooming a stereoscopic image, the method steps comprising:
dividing the image into a plurality of regions;
defining a value for each region;
selecting a zoom area having a boundary intersecting at least one of the regions;
comparing the values for the intersected regions to determine a preferred value based on predetermined criteria;
shifting the zoom area by the preferred value or a function of the preferred value.

14. A method for zooming a stereoscopic image comprising:
using an array of regions that divide the stereoscopic image into sections and
defining a value for each region.

15. The method of claim 14 wherein values associated with each region indicate a shift value that is used to adjust the relationship of the right and left image during a zooming operation.

16. The method of claim 14 wherein said sections and values are automatically determenined from a 3D object model.

17. The method of claim 14 wherein said sections and values are determined from a user input of depth values in said regions and interpolating values in between said regions.

18. The method of claim 14 wherein said sections and values are determenined using parallax adjustments for successive zooming operations dependent on a current zoom level.

19. The method of claim 14 further comprising using said sections and values with multiple levels of granularity for higher definition of sections and values in select areas of said image.
